(19) United States
(12) Patent Application Publication
(10) Pub. No.: US 2007/0281522 A1
(43) Pub. Date: Dec. 6, 2007

(54) Vertically Fitting Connector

(76) Inventor: Kazuya Okano, Kanagawa (JP)

Correspondence Address: HARRINGTON & SMITH, PC, 4 RESEARCH DRIVE, SHELTON, CT, 06484-6212, US

(21) Appl. No.: 10/593,837

(22) PCT Filed: Mar. 31, 2005
(86) PCT No.: PCT/JP05/06284

§ 371 Date: Jun. 20, 2007

(30) Foreign Application Priority Data
Mar. 31, 2004 (JP) 2004-107902

(51) Int. Cl. H01R 13/62

(52) U.S. Cl. 439/157; 439/345

(57) ABSTRACT

Connectors which can perpendicularly fit each other. The connectors are connected to a conductive line. On a housing of the connector, a first front protruding part and a side protruding part are formed in a direction toward the outside of the housing. The first front protruding part is formed on a front plane of the housing, and the side protruding part is formed on a side plane of the housing. The first front protruding part operates for positioning at the time of fitting and for maintaining the fit. The side protruding part operates as a latch for maintaining the fit.

### TECHNICAL FIELD

The present invention relates to a connector for making an electrical connection, particularly to a connector capable of fitting into a substrate roughly perpendicularly.

### BACKGROUND ART

The general popularity and improved performance of so-called mobile devices such as cellular phones in recent years has led to increases in the required specs. This has resulted in an increased desirability of compact connectors. Conventionally, connectors have been adapted to mobile devise and the like by simply forming them out of smaller connector bodies.

### DISCLOSURE OF THE INVENTION

Problems to be Solved by the Invention

However, one of the elements in achieving compact size and high performance of mobile devices is to make the space needed for fitting a connector, so-called dead space, as small as possible. In order to solve this problem, the present invention offers a connector capable of being fitted into a substrate in a roughly perpendicular direction while retaining adequate fitting strength.

Means for Solving the Problem

The invention offers a first connector connected to a conductor line, wherein on a housing of said connector are formed a first front projection and a side projection in directions facing outward from the housing, the first front projection being formed on a front surface of the housing, and the side projection being formed on a side surface of the housing; said first front projection functioning for positioning at the time of fitting and retaining the fit, and the side projection functioning as a latch for retaining the fit. As a result, the first connector can be reliably secured even if inserted roughly vertically into the corresponding connector.

In compact connectors, it is sometimes difficult to position the connectors when fitting them. Therefore, the invention offers a first connector connected to a conductor line, wherein on a housing of said connector are formed a first front projection in a direction facing outward from the housing and a first receiving portion, said first front projection functioning for positioning at the time of fitting and retaining the fit, and said first receiving portion engaging with a latch for retaining the fit. This is advantageous for the fitting of compact connectors. Additionally, the positioning can be made easier by forming two each of the first front projection and the first receiving portion.

Furthermore, the invention offers a connector said first side projection of said housing has an aperture portion for insertion of a fixing member to fix the first connector to the second connector. This structure is necessary to prevent the fit from coming loose.

Additionally, in order to reinforce the contact between the contacts, the invention offers a connector wherein said first side projection of said housing has an aperture portion for insertion of a fixing member to fix the first connector to the second connector. That is, the connector is prevented from curving upward by engagement with the projection.

Next, the invention offers, as a connector for receiving the first connector, a second connector fixed to a substrate, wherein on said connector are formed a first front receiving portion and a side receiving portion for receiving projections formed in a housing of a first connector, the first front receiving portion being formed on a side to which a conductor line of the first connector is not connected, and the side receiving portion being formed to right and left of a direction perpendicular to the direction of the conductor line of said first connector. As a result, a more reliable fit can be obtained by receiving the projection of the first connector.

Additionally, for retaining the fit, the invention offers a second connector fixed to a substrate, wherein on said connector are formed a first front receiving portion for receiving a projection formed in a housing of a first connector, and a bottom projection for engaging with the first connector, the first front receiving portion being formed on a side to which a conductor line of the first connector is not connected, and the bottom projection is formed on the insertion side of the first connector. The bottom projection is capable of reliably retaining the first connector. Furthermore, it is possible to form two each of the first front receiving portion and bottom projection, or for the side receiving portion to have a recess portion, so as to detain a portion received in the recess portion.

In order to make the fit of the connectors more reliable, the invention offers a second connector wherein the side receiving portion has a separately or integrally formed detaining portion for engaging a fixing member for fixing the first connector.

Due to the above structure, the first connector and second connector can be fit together in a direction roughly perpendicular to the substrate. Additionally, the invention offers a fixing member having a longitudinal shaft for retaining a fit between a first connector and a second connector, wherein said fixing member has a neck portion in a portion in the longitudinal direction, said longitudinal shaft passes through the aperture portion in accordance with claim 5, and said neck portion is detained by the detaining portion in accordance with claim 12.

### BRIEF DESCRIPTION OF THE DRAWING

FIG. 1 is a diagram showing the connector of the present invention before fitting.

FIG. 2 is a bottom view of a first and second connector of the present invention.

FIG. 3 is a top view of the area in the vicinity of the side projections of the first connector.

FIG. 4 is a bottom view of the area in the vicinity of the detaining member when fitting the first and second connectors.

### EXPLANATION OF REFERENCE NUMBERS

1 first connector
2 second connector
3 conductor line
4 housing
5 first front projection
6 side projection
7 first front receiving portion
8 side receiving portion
9 contact
10 bottom projection
11 overhang portion
12 shoulder portion
13 overhang portion
14 shield plate
15 second front projection
16 second receiving portion
17 engaging portion
18 fixing member
19 neck portion
20 detaining member
21 arm portion
22 collar portion
23 pressing portion

### BEST MODES FOR CARRYING OUT THE INVENTION

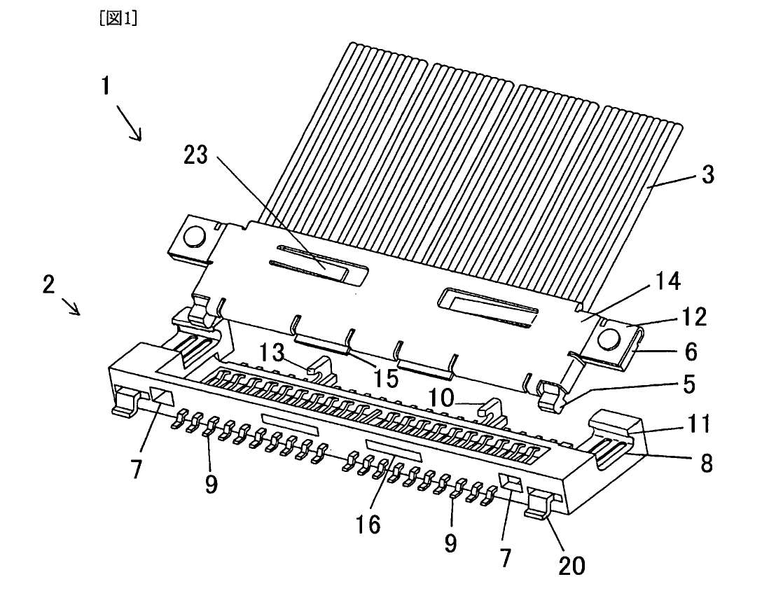

The examples of the present invention shall be described below with reference to the drawings. First, the structure of the connector of the present invention shall be described. FIG. 1 is a drawing showing the connector the present invention prior to fitting. A conductor line 3 is connected to the first connector 1, and a first front projection 5 is formed on the housing (not seen in this drawing) in a direction facing outward from the housing. Additionally, from this drawing, it can be seen that the first front projection 5 is formed on the front surface of the housing. Additionally, a side projection 6 is further formed on this housing. As can be seen in FIG. 1, the side projections are formed on right and left side surfaces of the housing.

Additionally, a second connector 2 has a first front receiving portion 7 for receiving the first front projection 5 of the first connector 1. It is clear from the drawing that the first front receiving portion 7 is formed on a side where the conductor line 3 of the first connector 1 is not connected. Furthermore, a side receiving portion 8 for receiving the side projection 6 of the first connector is formed on the second connector 2. The position at which the side receiving portion 8 is formed is clear from the drawing, it being formed at right and left sides with respect to a direction perpendicular to the conductor line 3 of the first connector 1 when the first connector 1 and second connector 2 are fitted together. Thus, according to FIG. 1, it can be seen to be outside the area at which the contact 9 of the second connector 2 is formed.

The side receiving portion 8 of the second connector 2 has an overhang portion 11 for detaining said side projection 6 when receiving the side projection 6. By engaging with the shoulder portion 12 of the side projection 6, the overhang portion 11 can function as a latch.

Furthermore, a bottom projection 10 is formed in the second connector. This bottom projection 10 has an overhang portion 13 similar to that of the side receiving portion 8, and can engage with a corresponding portion of the first connector 1.

According to FIG. 1, a shield plate 14 is attached to the first connector 1. The shield plate 14 is positioned on a ground bar (not shown in FIG. 1), with a pressing portion 23 contacts the ground bar, and further has a second front projection 15. The second front projection 15 is received in a second front receiving portion 16 which is a portion corresponding to the second connector 2. Thus, it is possible to prevent the central portion of the first connector from curving upward after fitting.

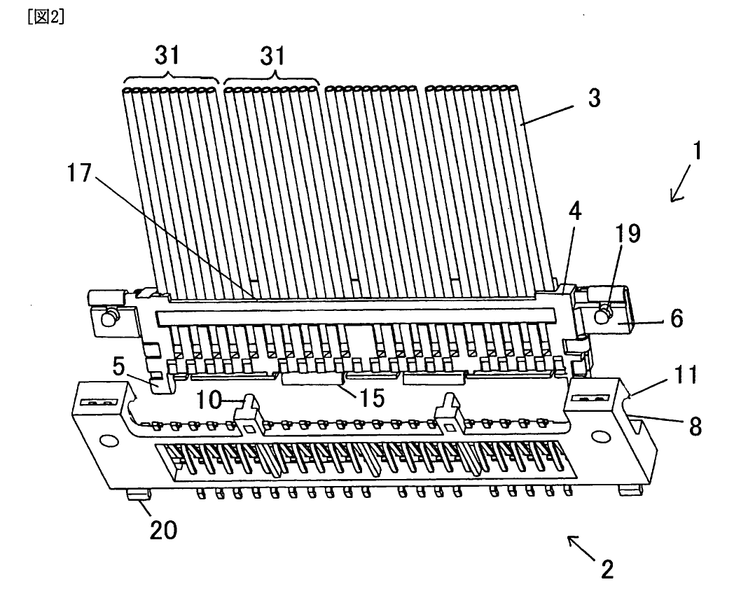

Next, referring to FIG. 2, FIG. 2 is a bottom view of the connector of the present invention, the first connector 1 comprising an engaging portion 17 capable of engaging with the aforementioned bottom projection 10. In order to provide space for engagement of the engaging portion 17, there are no conductor lines 3 corresponding to this portion. The engaging portion 17 is a portion of the housing, which by engaging with an overhang portion 13 of the bottom projection 10 as described below, performs the function of holding the fit between the first connector 1 and the second connector 2. As is clear from the drawing, this engaging portion 17 is positioned between conductor line bundles 31. However, the invention is not limited to such a structure, and it is sufficient to have a structure capable of engaging with the first connector.

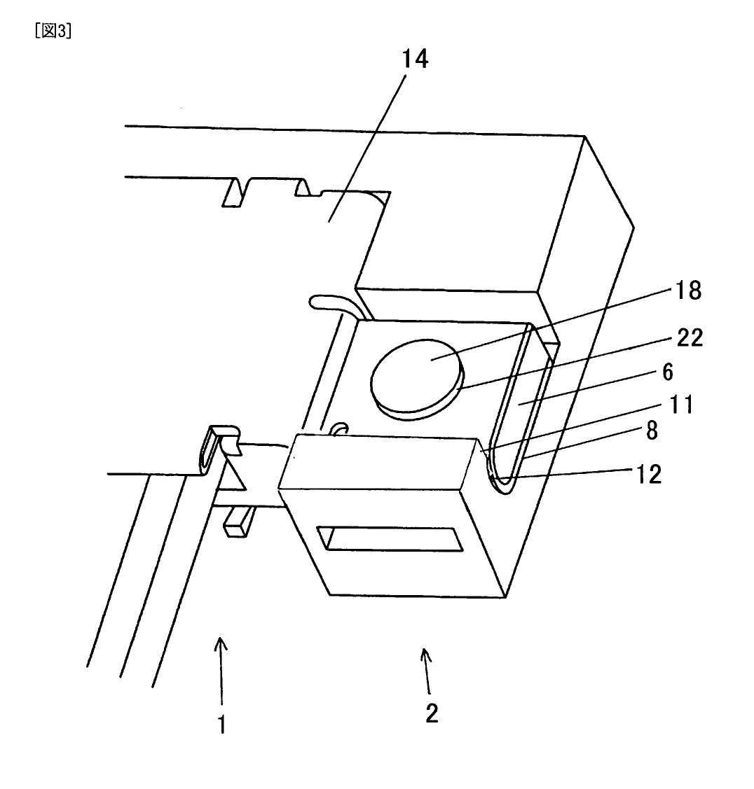

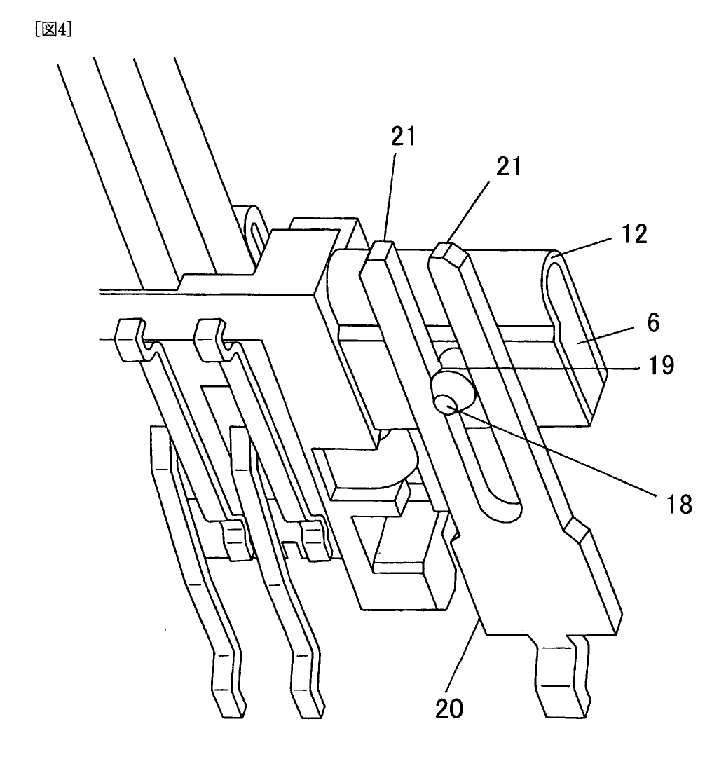

The connector of the present invention further has a member for reliably retaining the fit. First, a side projection 6 is formed in the first connector as shown in FIG. 3, this being received in the side receiving portion 8 of the second connector 2, and the overhang portion 11 and shoulder portion 12 are engaged. Here, a through hole (not shown in the drawing) is formed in the side projection 6, and a fixing member 18 is inserted. This fixing member has a collar portion 22, and contacts the side projection 6 or a shield plate 14 on the first connector. Additionally, a longitudinal shaft is formed on the fixing member 18, and a neck portion 19 is formed on this longitudinal shaft as shown in FIG. 4.

This fixing member 18 is detained by a detaining member 20 on the second connector 2 side. As shown in FIG. 4, the detaining member 20 has two arm portions 21, which engage with the neck portion 19 formed in the longitudinal shaft of the fixing member 18 passing through the side projection 6. Those skilled in the art will recognize that the spacing of the arm portions 21 is smaller than the maximum diameter of the longitudinal shaft of the fixing member, and about the same as the diameter of the neck portion 19.

A detaining member 20 is provided on the second connector as shown in FIGS. 1 and 2.

Next, the operations for fitting the first connector 1 and the second connector 2 shall be explained with reference to FIGS. 1 and 2. With reference to FIG. 1, the first front projection 5 is first inserted into the first front receiving portion 7 of the second connector 2. This front projection 5 can perform the functions of guiding and positioning. At this time, the second front projection is also inserted into the second front receiving portion 16.

After inserting the first and second front projections into corresponding parts, the first connector is pushed down roughly perpendicular with respect to the substrate (not shown) of the first connector. That is, in FIG. 1, the second connector is provided on the substrate, so it is pushed down roughly perpendicular to the second connector. At this time, there is a latch mechanism for retaining the fit between the first and second connectors as described above, so that the overhang portions 11 and 13 respectively contact the shoulder portion 12 and the engaging portion 17 (see FIG. 2). Therefore, upon applying further pressure, these overhang portions 11 and 13 respectively engage with the shoulder portion 12 and the engaging portion 17, so as to fit together the first connector 1 and second connector 2.

In order to more strongly retain this fit, the fixing member 18 is inserted into a through hole of the side projection 6 of the first connector 1.

The structure and operations of the present invention have been described above. The present invention is not limited to these embodiments, and for example, the fixing member 18 may be formed integrally with the side projection 6 of the first connector 1. Additionally, the positional relationship between the fixing member 18 and the detaining member 20 may be reversed. That is, it is possible to form an aperture portion for insertion of the fixing member 18 on the second connector 2, and provide the detaining member 20 on the first connector 1. Additionally, the fixing member 18 may be formed integrally with the second connector 2.

Additionally, the connector of the present invention can retain the fit with the first front projection 5 and side projection 6 of the first connector. The function of retaining the fit can also be performed by the front projection 5 and the bottom projection 10, or by a combination of the front projection 5, the side projection 6 and the bottom projection 10. The present invention is characterized in being able to be fit together roughly perpendicularly, and this can be effectively achieved by providing electrical parts in areas that formed dead space n the past, due in particular to the flexibility of conductor lines connected to compact connectors.

1. A first connector connected to a conductor line, wherein on a housing of said connector are formed a first front projection and a side projection in directions facing outward from the housing, the first front projection being formed on a front surface of the housing, and the side projection being formed on a side surface of the housing; said first front projection functioning for positioning at the time of fitting and retaining the fit, and the side projection functioning as a latch for retaining the fit.

2. A first connector connected to a conductor line, wherein on a housing of said connector are formed a first front projection in a direction facing outward from the housing and a first receiving portion, said first front projection functioning for positioning at the time of fitting and retaining the fit, and said first receiving portion engaging with a latch for retaining the fit.

3. A connector in accordance with claim 1, having two each of the first front projection and the side projection.

4. A connector in accordance with claim 2, having two each of the first front projection and the first receiving portion.

5. A connector in accordance with claim 1, wherein said first side projection of said housing has an aperture portion for insertion of a fixing member to fix the first connector to the second connector.

6. A connector in accordance with claim 1, wherein a tip of a shield plate positioned on a ground bar has a second front projection, and said second front projection engages with a corresponding portion to prevent the connector from curving upward.

7. A second connector fixed to a substrate, wherein on said connector are formed a first front receiving portion and a side receiving portion for receiving projections formed in a housing of a first connector, the first front receiving portion being formed on a side to which a conductor line of the first connector is not connected, and the side receiving portion being formed to right and left of a direction perpendicular to the direction of the conductor line of said first connector.

8. A second connector fixed to a substrate, wherein on said connector are formed a first front receiving portion for receiving a projection formed in a housing of a first connector, and a bottom projection for engaging with the first connector, the first front receiving portion being formed on a side to which a conductor line of the first connector is not connected, and the bottom projection is formed on the insertion side of the first connector.

9. A connector in accordance with claim 7, having two each of the first front receiving portion and the side receiving portion.

10. A connector in accordance with claim 8, having two each of the first front receiving portion and the bottom projection.

11. A connector in accordance with claim 7, wherein the side receiving portion has a recess portion, and a portion received in said recess portion is detained.

12. A connector in accordance with claim 7, wherein the side receiving portion has a separately or integrally formed detaining portion for engaging a fixing member for fixing the first connector.

13. A connector in accordance with claim 1, which is connected to a substrate by attaching the first connector to which a conductor line is connected to a second connector, wherein the first connector to which the conductor lines are connected can be fit roughly perpendicularly with respect to the corresponding second connector and a substrate.

14. A connector in accordance with claim 7, which is connected to a substrate by attaching a first connector to which a conductor line is connected to the second connector, wherein the second connector fixed to a substrate receives the corresponding first connector in a direction roughly perpendicular with respect to the substrate.

15. A fixing member having a longitudinal shaft for retaining a fit between a first connector and a second connector, wherein said fixing member has a neck portion in a portion in the longitudinal direction, said longitudinal shaft passes through the aperture portion in accordance with claim 5, and said neck portion is detained by the detaining portion in a connector wherein the side receiving portion has a separately or integrally formed detaining portion for engaging a fixing member for fixing the first connector.
